(19) United States
(12) Patent Application Publication
(10) Pub. No.: US 2014/0367341 A1
(43) Pub. Date: Dec. 18, 2014

(54) COAGULANT, COAGULATION METHOD, AND WATER TREATMENT APPARATUS

(71) Applicant: Hitachi, Ltd., Tokyo (JP)

(72) Inventors: Hiroshi Sasaki, Tokyo (JP); Akira Mochizuki, Tokyo (JP); Hisashi Isogami, Tokyo (JP)

(21) Appl. No.: 14/369,723

(22) PCT Filed: Oct. 29, 2012
(86) PCT No.: PCT/JP2012/077904

§ 371 Date: Jun. 30, 2014

(30) Foreign Application Priority Data
Feb. 27, 2012 (JP) 2012-039519

(51) Int. Cl. C02F 1/52; C08K 3/20; C08K 9/02; C02F 1/48; C02F 1/66

(52) U.S. Cl. CPC C02F 1/5236; C02F 1/5281; C02F 1/488; C02F 1/66; C08K 9/02; C08K 3/20; C02F 2101/32
USPC 210/695; 210/205; 252/62.54

(57) ABSTRACT

In order to rapidly remove an organic acid dissolved in contaminated water, a coagulant capable of forming a floc with the organic acid in the contaminated water is configured to include an iron oxide bearing an inorganic acid on surface thereof, and an aqueous solution of an acidic-group-containing polymer. Upon removal of the organic acid as a floc from the contaminated water using the coagulant, the iron oxide bearing an inorganic acid on surface is initially added to the contaminated water, and then the aqueous solution of the acidic-group-containing polymer is added to precipitate a floc, and the floc is magnetically separated. A water treatment apparatus enabling removal of an organic substance from contaminated water is provided with a mechanism for stirring the contaminated water, a mechanism for adding an iron oxide bearing an inorganic salt on surface to the contaminated water, a mechanism for adding an aqueous solution of an acidic-group-containing polymer to form a floc, and a mechanism for magnetically separating the formed floc.

### TECHNICAL FIELD

The present invention relates to an agent and a method for coagulation, and a water treatment apparatus each for the remediation of contaminated water.

### BACKGROUND ART

Mining of oil fields gives contaminated water called “associated water” together with crude oils; and contaminated water from oil sands. The crude oils and oil sands contain large amounts of organic acids such as acetic acid, valeric acid, and naphthenic acid, and the contaminated water thereby contains large amounts of organic acids. These organic acids will significantly affect the ecological system and should therefore be removed from the contaminated water when the contaminated water is to be released to oceans or rivers.

Patent Literature 1 discloses a technique of adding a polyacrylamide and a poly aluminum chloride (so-called “PAC”) or iron sulfate to form a large floc, incorporating a magnetic powder into a floc upon the formation of the floc, and magnetically separating the floc. This technique, however, fails to remove organic acids (e.g., acetic acid, valeric acid, and naphthenic acid) dissolved in the contaminated water, although the technique enables removal of contaminant fine particles from the contaminated water. This is because such organic acids each have a carboxyl group or groups not in free form but in the form of a salt such as ammonium salt or sodium salt and are thereby further soluble in water.

Patent Literature 2 discloses a technique of removing an organic acid or a salt thereof through flocculation. In this technique, an amino-containing polymer is initially added to contaminated water to allow a carboxyl group of the organic acid in the contaminated water to form an ionic bond with the amino group of the amino-containing polymer. An acidic-group-containing polymer is added in this state, and this allows the acidic groups of the acidic-group-containing polymer and amino groups of the amino-containing polymer to form intermolecular ionic bonds at plural sites to thereby form a floc insoluble in water. Thus, even an organic acid dissolved in water can be removed from the contaminated water.

### PRIOR ART DOCUMENT

### Patent Literature

[Patent Literature 1] Japanese Unexamined Patent Application Publication No. 2003-144805
[Patent Literature 2] Japanese Unexamined Patent Application Publication No. 2010-172814

### SUMMARY OF THE INVENTION

### Problem to be Solved by the Invention

However, flocculation according to the techniques disclosed in JP-A No. 2003-144805 and JP-A No. 2010-172814 proceeds too fast to allow the resulting flocs to include a magnetic powder, if added. This disadvantageously induces magnetic separation of the flocs only partially.

An object of the present invention is to provide better performance, particularly higher speed, of magnetic separation of an organic acid.

### Means for Solving the Problem

To achieve the object, the present invention provides, in an aspect, a coagulant capable of forming a floc with an organic acid in contaminated water. The coagulant includes an iron oxide bearing an inorganic salt on surface; and an aqueous solution of an acidic-group-containing polymer.

The present invention provides, in another aspect, a method for the remediation of contaminated water by converting an organic acid in the contaminated water into a floc, and removing the floc. The method includes the steps of adding an iron oxide bearing an inorganic salt on surface to the contaminated water; adding an aqueous solution of an acidic-group-containing polymer to the contaminated water to precipitate a floc; and magnetically separating the precipitated floc.

In addition and advantageously, the present invention provides a water treatment apparatus for the remediation of contaminated water. The apparatus includes a mechanism for stirring the contaminated water; a mechanism for adding an iron oxide bearing an inorganic salt on surface to the contaminated water; a mechanism for adding an aqueous solution of an acidic-group-containing polymer to the contaminated water to form a floc; and a mechanism for magnetically separating a formed floc.

### Advantageous Effect of the Invention

The present invention provides better performance of magnetic separation of an organic acid.

### BRIEF DESCRIPTION OF THE DRAWINGS

FIG. 1 is a schematic diagram illustrating a scheme of surface modification of a magnetic powder according to an embodiment of the present invention.

FIG. 2 is a schematic diagram illustrating a scheme of floc formation according to an embodiment of the present invention.

FIG. 3 is a schematic diagrams of water treatment apparatuses according to embodiments of the present invention.

FIG. 4 is a schematic diagrams of water treatment apparatuses according to embodiments of the present invention.

FIG. 5 is a schematic diagrams of water treatment apparatuses according to embodiments of the present invention.

FIG. 6 is a schematic diagrams of water treatment apparatuses according to embodiments of the present invention.

FIG. 7 is a schematic diagram of oil extraction and water remediating system according to an embodiment of the present invention.

### MODE FOR CARRYING OUT THE INVENTION

The present invention performs formation of a floc including an organic acid from contaminated water in combination with a magnetic powder through the following processes (a), (b), and (c).

(a) Surface Modification of Magnetic Powder

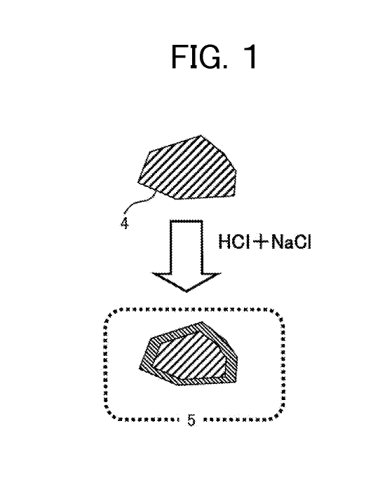

With reference to FIG. 1, a magnetic powder 4 is dispersed in a stirred aqueous solution of a strong acid for the slight ionization of the surface of the magnetic powder 4. The strong acid is typified by hydrochloric acid, sulfuric acid, and nitric acid. The magnetic powder 4 is exemplified by an iron oxide powder.

This process gives a surface-modified magnetic powder 5. The surface modification herein may be enhanced by the addition of an inorganic salt such as sodium chloride.

(b) Organic Acid Trap

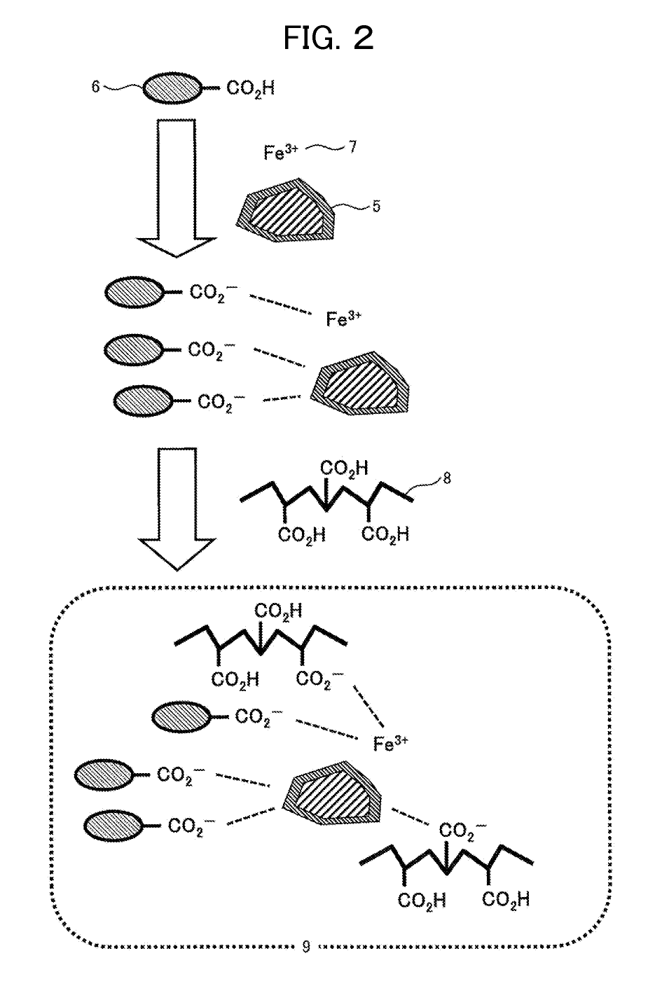

With reference to FIG. 2, the magnetic powder 5 is added to contaminated water containing an organic acid 6 dissolved therein to allow the organic acid 6 to form an ionic bond with an ion on the surface of the magnetic powder 5. A trivalent metal salt may further be added in addition to the magnetic powder 5. A metal salt having an iron ion 7 is added herein. The trivalent metal salt to be added to the contaminated water is typified by an iron chloride, an iron sulfate, and a poly aluminum chloride.

(c) Floc Formation

Next, an acidic-group-containing polymer is added. A carboxyl-containing polymer 8 is added as the according to the present invention in the embodiment in FIG. 2. In this process, the carboxyl groups form ionic bonds with the iron ion 7 or the surface-modified magnetic powder 5 each previously added, to form intermolecular crosslinks, and thereby give a floc insoluble in water. Thus, a floc 9 including the organic acid and the magnetic powder is formed. The present invention is intended to remove an organic acid having a substituent for the formation of an ionic bond, in which the organic acid ionically bonds with the coagulant to form a floc. Specifically, the “contaminated water” to be treated according to the present invention refers to one containing an organic acid and is typified by seawater, river water, oil-contaminated water, sewage, and drainage water.

The coagulant may also employ any of salts of trivalent metals other than iron salts and aluminum salts. Exemplary salts of other trivalent metals include salts of rare-earth metals such as neodymium and dysprosium, which are typified by neodymium chloride and dysprosium chloride.

While the trivalent metal salt and the water-soluble acidic-group-containing polymer may be effective even when added as a bulk, they are preferably added as aqueous solutions. This is because such a bulk coagulant takes much time to spread over the contaminated water. In particular, if a water-soluble acidic-group-containing polymer is added before a trivalent metal salt is sufficiently dissolved, flocculation may occur only partially in the contaminated water, and this may impede the removal of an organic acid. Also to avoid this, the components are preferably added as aqueous solutions.

The trivalent metal salt (such as iron salt or aluminum salt) is preferably added in such an amount that almost all the metal ions and acidic groups form ionic bonds with each other, because metal ions of the trivalent metal salt form ionic bonds with carboxyl groups of the organic acid and with the acidic groups of the water-soluble acidic-group-containing polymer. Specifically, the trivalent metal salt is preferably added in such an amount as to satisfy the following inequality expression:

3M≧MA+PA

wherein M represents the number of moles of metal ion of the metal salt; PA represents the number of moles of acidic group of the acidic-group-containing polymer; and MA represents the number of moles of the organic acid in the contaminated water.

Customary techniques for removing organic acids most generally employ ion-exchange resins. In such an ion-exchange resin, an organic acid is trapped by amino group on the surface of resin particles having a particle diameter of about 0.1 to 2 mm. With a decreasing particle diameter, the resin particles have larger surface areas and can thereby trap a larger amount of the organic acid. By contrast, the present invention employs a water-soluble coagulant to be added and can thereby trap an organic acid with such a high efficiency as if ion-exchange resin particles having a particle diameter of several angstroms are used. The coagulant according to the present invention can trap an organic acid in a significantly larger amount than the customary ion-exchange resin does, assuming that the respective agents are added in an equal amount.

Embodiments of the present invention will be illustrated below.

[1] Coagulant

(1) Magnetic Powder

A magnetic powder to be used herein is modified on the surface with a strong acid before use.

Specifically, the term “modification” refers to ionization of iron atoms on the surface of the magnetic powder. Typically, when hydrochloric acid is used as the strong acid, the surface of the magnetic powder becomes an iron chloride. The iron chloride is probably present as being monovalent on average, because divalent and trivalent ones have been dissolved in water. Although the valency of the iron chloride is difficult to be identified because of an enormous number of atoms present on the surface, an analysis of the surface typically with a scanning electron microscope with energy dispersive analysis (SEM/EDX) reveals the presence of chlorine on the surface, suggesting that a thin surface layer turns into an iron chloride.

The surface of the magnetic powder itself has turned into cationic iron ions and can be conically bonded with an organic acid or an acidic-group-containing polymer. This facilitates inclusion of the magnetic powder in a floc. In fact, most of flocs after flocculation include the magnetic powder, and they can be magnetically collected or recovered in the subsequent magnetic separation.

Upon surface modification with a strong acid, the magnetic powder is initially immersed in the strong acid, retrieved from the strong acid, washed with water, dried, and thereby yields a surface-modified magnetic powder. The surface-modified magnetic powder is used herein for the remediation of contaminated water.

A regular magnetic powder without the modification, if used, is included in only part of flocs, and this impedes collection of part of flocs through magnetic separation. By contrast, the present invention enables application of magnetic separation to removal of organic acids.

The magnetic powder may be a powder of iron (Fe) or an iron oxide such as Fe₃O₄ or Fe₂O₃, each of which can be collected by the action of magnetism.

The surface modification may be performed according to the following procedure. Initially, an inorganic strong acid such as hydrochloric acid, sulfuric acid, or nitric acid is placed in a vessel containing the magnetic powder, followed by stirring for about one hour. The strong acid, when being a monovalent acid such as hydrochloric acid or nitric acid, may be added in an amount as much as about 3 times the number of moles of iron atoms in iron or an iron oxide; and, when being a divalent sulfuric acid, may be added in an amount as much as about 1.5 times the number of moles of iron atoms.

Next, the magnetic powder is collected by filtration, washed with water, dried under reduced pressure, and thereby yields a surface-modified magnetic powder. The concentration of an inorganic strong acid, when used alone, may be as follows. Hydrochloric acid, when employed, may be used in a concentration of about 3 to about 11 percent by weight. Hydrochloric acid in a concentration of less than 3 percent by weight may little dissolve the surface of the magnetic powder. Hydrochloric acid in a concentration of more than 11 percent by weight may excessively dissolve the magnetic powder and reduce the same to approximately half. For the same reason, sulfuric acid is preferably used as an aqueous solution in a concentration of 5 to 16 percent by weight, whereas nitric acid is preferably used as an aqueous solution in a concentration of 6 to 18 percent by weight.

The use of a strong acid in such a concentration may probably accelerate corrosion of pipes and other facilities. To avoid this, a neutral salt such as sodium chloride may be added previously. The neutral salt is preferably added in such an amount as to be 5 percent by weight or more after the addition of the strong acid. This helps the strong acid such as hydrochloric acid, sulfuric acid, or nitric acid to achieve surface modification even when each used in a concentration of about 1 percent by weight.

The neutral salt to be added is typified by sodium chloride, sodium sulfate, sodium nitrate, potassium chloride, potassium sulfate, potassium nitrate, magnesium chloride, magnesium sulfate, magnesium nitrate, calcium chloride, calcium sulfate, and calcium nitrate.

A strong acid containing an organic substance such as trichloroacetic acid or trifluoroacetic acid, if used instead of an inorganic strong acid, can remain in the magnetic powder even after surface modification and can dissolve also in the contaminated water. In this case, the treatment, even though performed with the intension to remove organic acids from the contaminated water, contrarily increases the concentration of organic acids. To avoid this, an inorganic strong acid is used herein.

(2) Acidic-Group-Containing Polymer

Possible acidic-group-containing polymers are typified by polymers containing carboxyl groups and polymers containing sulfonic groups.

Of polymers containing carboxyl groups, poly acrylic acids are most preferred for inexpensiveness and for easy ionic bonding with a trivalent metal ion. Independently, polymers derived from amino acids, such as poly spartic acids and poly glutamic acids, are advantageous in their low toxicity.

Alginic acid is one of main components of kelp and other seaweed, is available from a biological material, and thereby advantageously less affects the environment.

The polymers having sulfonic groups are typified by poly vinylsulfonic acids and poly styrenesulfonic acids. The sulfonic groups have an acidity larger than that of carboxyl groups, form ionic bonds with metal ions in a higher percentage to give a stable floc, and are preferred.

Polymers having carboxyl groups are widely used typically as diapers and sanitary products, readily available, inexpensive, and, in these points, more advantageous than polymers having sulfonic groups.

An acidic-group-containing polymer, if having low solubility in water, can exhibit a higher solubility in water by structurally converting the acidic group into an ammonium salt, sodium salt, or potassium salt. The acidic-group-containing polymer, when added to the contaminated water after conversion into an ammonium salt, sodium salt, or potassium salt, can efficiently form ionic bonds with trivalent metal ions.

The acidic-group-containing polymer, if having an excessively small average molecular weight, may give a floc with low stability due to small number of crosslinking points of the floc and may be liable to give flocs which are viscous and fluidal. Such flocs are difficult to be removed by filtration. To avoid this, the acidic-group-containing polymer preferably has an average molecular weight of 2,000 or more.

An acidic-group-containing polymer having an average molecular weight of 2,000 may give a viscous floc at a temperature of the contaminated water of 40° C. or higher. The temperature of the contaminated water, when being oil sand waste water, may be up to about 60° C. In this case, further increase in average molecular weight of the polymer may enable the solidification of a floc even at a high temperature. Specifically, an acidic-group-containing polymer having an average molecular weight of 5,000 or more, when used, may enable solidification of a floc even at a temperature of the contaminated water of 40° C. The acidic-group-containing polymer therefore more preferably has an average molecular weight of 5,000 or more. In addition, an acidic-group-containing polymer having an average molecular weight of 10,000 or more, when used, may enable the solidification of a floc even at a temperature of the contaminated water of 60° C. The acidic-group-containing polymer therefore furthermore preferably has an average molecular weight of 10,000 or more.

An acidic-group-containing polymer having an excessively high molecular weight, however, may tend to have a lower solubility in water and precipitate during the process of forming crosslinks with trivalent metal ions. Specifically, this acidic-group-containing polymer can precipitate in the contaminated water before all trivalent metal ions in ionic bonding state form crosslinks with organic acids through ionic bonding. This causes part of trivalent metal ions in ionic bonding state and the organic acids to remain as dissolved in the contaminated water. To avoid this, the acidic-group-containing polymer desirably has an average molecular weight of 1,000,000 or less.

As used herein the term “average molecular weight” of a polymer refers to a number-average molecular weight of the polymer, which may be measured by gel permeation chromatography.

(3) Metal Salt

The metal species in the metal salt is typified by trivalent metals such as iron, aluminum, neodymium, and dysprosium. Among them, iron and aluminum are abundant on the earth, readily available inexpensively, and are preferred; of which iron is more preferred for more inexpensiveness.

The iron salt preferably structurally includes no carbon so as not to increase the chemical oxygen demand (COD) of the contaminated water. For this reason, the iron salt is preferably in the form of a salt of not an organic acid (e.g., iron acetate or iron propionate) but an inorganic acid (e.g., iron chloride, iron sulfate, or iron nitrate).

The coagulant, when further containing such a metal salt in addition to the surface-modified magnetic powder, enables more easy formation of flocs, because the metal salt is an ionic compound.

The aluminum salt is typified by a poly aluminum chloride. The poly aluminum chloride is synthetically prepared by adding hydrochloric acid to aluminum hydroxide and has a structure of [Al₂(OH)ₙCl₆₋ₙ]ₘ, wherein n and m satisfy conditions: 1≦n≦5 and m≦10.

The aluminum salt is further typified by aluminum sulfate.

When the metal species in the metal salt is a rare-earth metal such as neodymium or dysprosium, the metal salt is preferably a salt of hydrochloric acid, sulfuric acid, or nitric acid, for high solubility in water.

(4) Additives for Better Organic Acid Trap

The organic acid, when having an acidic group with a low acidity, forms an ionic bond with a trivalent metal ion in a low percentage. In this case an inorganic salt such as sodium chloride or potassium chloride is added to the contaminated water before the addition of the acidic-group-containing polymer. This may allow the organic acid to form an ionic bond with a trivalent metal ion in a higher percentage. This is probably because the addition of an inorganic salt reduces an allowable limit of the organic acid to be dissolved in the contaminated water by an effect similar to that of salting-out. In salting out, a salt is added to precipitate an organic substance dissolved in water.

The inorganic salt to be added is typified by hydrochloric acid salts (chlorides) of alkali metals and alkaline earth metals, such as sodium chloride, potassium chloride, magnesium chloride, and calcium chloride; sulfates of alkali metals and alkaline earth metals, such as sodium sulfate, potassium sulfate, magnesium sulfate, and calcium sulfate; and nitrates of alkali metals and alkaline earth metals, such as sodium nitrate, potassium nitrate, magnesium nitrate, and calcium nitrate.

The coagulant according to the present invention may exhibit high performance for flocculating and removing an organic acid when the contaminated water has a pH in the range of weakly acidic to neutral. Specifically, the coagulant may exhibit optimal performance at a pH of the contaminated water of 5 to 7. The coagulant according to the present invention forms a floc with the organic acid through ionic bonding. The resulting floc is stable at a pH of 5 to 7 and, within this pH range, flocculation and removal of the organic acid may be performed optimally. Removal of the organic acid is possible even when the contaminated water has a pH out of this range, but this may result in a low rate of removal or may require an increased amount of a metal salt to be added.

The contaminated water has a pH shifting toward acidic upon addition of a metal salt such as iron chloride or aluminum sulfate. The contaminated water also has a pH shifting toward acidic upon the addition of an acidic-group-containing polymer. A floc is stable as an insoluble substance in water at a pH of 2 to 5 and becomes more soluble in water at a pH out of this range. Accordingly, the contaminated water optimally has a pH of 5 to 7 before the addition of an acidic-group-containing polymer and a metal salt.

[2] Flocculation Method

(1) Summary of Flocculation Method According to the Present Invention

A method for forming an organic acid into a floc will be simply illustrated as processes (a), (b), (c), (d), and (e) below, with reference to FIG. 2. Carboxyl group is illustrated as the acidic group in an embodiment in FIG. 2, but the following description is also true in the case of sulfonic group when used as the acidic group.

(a) A surface-modified magnetic powder 5 and an aqueous solution of a trivalent metal salt are added to contaminated water containing an organic acid 6. In FIG. 2, an iron chloride 7 is illustrated as the trivalent metal salt.

(b) The surface-modified magnetic powder 5 and the iron ion 7 in iron chloride ionically bond with the organic acid in the contaminated water.

(c) An aqueous solution of an acidic-group-containing polymer 8 is added to the contaminated water. In FIG. 2, a carboxyl-containing polymer 8 is illustrated as the acidic-group-containing polymer.

(d) The iron ion 7 and the surface of the magnetic powder 5 ionically bond with the carboxyl group of the organic acid 6 and with the carboxyl group of the carboxy-containing water-soluble polymer 8.

(e) A floc 9 insoluble in water is formed.

(2) Way to Improve Organic Acid Removal

The way to improve the rate of removal of the organic acid is typified by addition of an inorganic salt to the contaminated water before the addition of the polymer. The addition of an inorganic salt may probably increase the rate of removal by an effect similar to that of salting-out, as has been described above. The inorganic salt to be added is preferably sodium chloride which is abundant in nature. Sodium chloride is particularly preferred in treatment of contaminated water from submarine oil fields. This is because an average sodium chloride concentration in seawater is about 3%, and the addition of sodium chloride up to this level will trivially affect the environment.

The inorganic salt is added before the addition of the polymer. This is because the inorganic salt, if added after the addition of the polymer, may not further contribute to flocculation.

The rate of organic acid removal may also be improved by controlling the contaminated water to have a pH of 5 to 7 before the addition of the acidic-group-containing water-soluble polymer, as has been described above.

(3) Upsizing of Flocs

The addition of a solution of an acidic-group-containing polymer, if performed with excessively vigorous stirring, may cause flocs to have excessively small sizes. Such flocs having excessively small sizes may be liable to clog a filter layer upon filtration, resulting in a low treatment speed.

It has been found that sand, oil droplets, and other suspended matter, when coexisting with the contaminated water, is included in flocs upon flocculation to allow the flocs to be grown in size. They have also found that sand is suitable for the removal of flocs typically through filtration, because the sand has a high specific gravity and, when included in the flocs, allows the flocs to have a higher specific gravity and to precipitate more readily.

(4) Removal of Suspended Matter

It has been found that the coagulant according to the present invention is capable of removing suspended matter together with an organic acid, while the coagulant is intended to remove the organic acid from the contaminated water. The coagulant therefore avoids the need for flocculation with a poly aluminum chloride and a polyacrylamide generally employed in customary techniques for suspended matter removal and advantageously leads to reduction in load (cost and treating time) of water remediation process.

[3] Embodiments of Water Treatment Apparatus

Next, water treatment apparatuses according to embodiments of the present invention will be illustrated below.

(1) First Embodiment of Water Treatment Apparatus

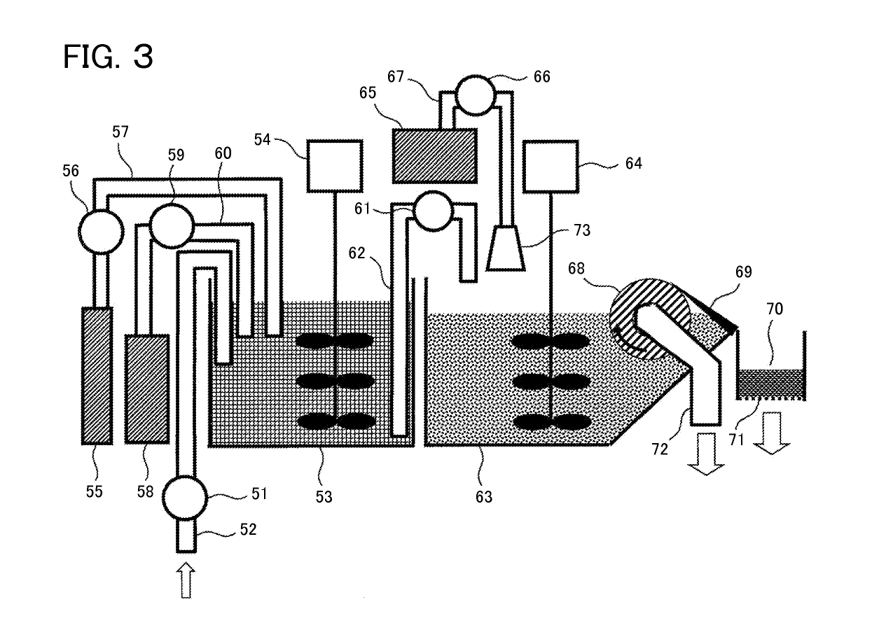

Of water treatment apparatuses according to the present invention, one employing a magnetic separation system will be illustrated on its basic structure with reference to FIG. 3.

Contaminated water is fed via a pipe 52 to a first mixing chamber 53 using a pump 51. The liquid in the chamber is stirred by an overhead stirrer 54. The pH of the contaminated water is determined herein. A pH sensor (not shown) for determining the pH is provided in the first mixing chamber 53. The apparatus may include two or more first mixing chambers 53.

When the contaminated water has a pH of more than 7, dilute hydrochloric acid is fed from a dilute hydrochloric acid reservoir 55 via a pipe 57 to the first mixing chamber 53 using a pump 56.

When the contaminated water has a pH of less than 5, not the dilute hydrochloric acid but an aqueous sodium hydroxide solution is added. The pH of the contaminated water is controlled in this manner.

Independently, a trivalent metal salt and an alkali metal salt or alkaline earth metal salt are dissolved in water to give an aqueous solution of metal salts, and the aqueous solution and an iron oxide are stored in a reservoir 58. The aqueous solution of metal salts together with the iron oxide are then fed from the reservoir 58 via a pipe 60 to the first mixing chamber 53 using a pump 59, followed by mixing them with the contaminated water.

The resulting mixture is fed from the first mixing chamber 53 via a pipe 62 to a second mixing chamber 63 using a pump 61. The mixture in the second mixing chamber 63 is stirred by an overhead stirrer 64.

The reservoir 58 for storing the aqueous solution of metal salts is preferably provided with an overhead stirrer or another stirring mechanism (not shown) for mixing the aqueous solution of the trivalent metal salt and the alkali metal salt or alkaline earth metal salt with the magnetic powder. This is because the magnetic powder has a specific gravity higher than that of water and may sink downward in the reservoir. The aqueous solution of metal salts and the magnetic powder may be added separately to the second mixing chamber 63, but such separate addition may often cause flocs to contain the magnetic powder in an uneven density per unit volume. To avoid this, the magnetic powder and the aqueous solution of metal salts are preferably mixed with each other before being fed to the second mixing chamber 63, as in this apparatus. Mixing of these components previously in the first stirring chamber 53 may also exhibit similar effects.

Next, an aqueous solution of an acidic-group-containing polymer is fed from a reservoir 65 for the aqueous solution of an acidic-group-containing polymer via a pipe 67 to the second mixing chamber 63 using a pump 66, to form flocs in the second mixing chamber 63.

The formed flocs contain the magnetic powder. The flocs adhere to a drum 68 which has a meshed, magnetized surface. The drum 68 rotates clockwise in FIG. 3, and the flocs adhered to the surface of the drum are stripped off from the mesh of the drum 68 by a scraper 69. The stripped flocs 70 are collected in a floc collection device 71 which has a meshed bottom. The flocs 70 immediately after collection contain a considerable amount of water, and the water is drained through the mesh at the bottom of the floc collection device 71. The drum 68 may rotate counterclockwise so as to increase adhesion of the flocs 70. In this case, the scraper 69 and the floc collection device 71 are arranged at opposite positions with respect to the drum 68.

On the other hand, the water passed through the mesh of the drum 68 is one from which the flocs have been removed by the action of the mesh. The water, from which the flocs have been removed, is discharged via a pipe 72 arranged at the center part of the drum 68.

A nozzle 73 of the pipe 67 for feeding a liquid to the second mixing chamber 63 is preferably not straight but reverse-tapered (widened) in a fan like form or in the form of a shower head so as to feed the liquid to an area as wide as possible in the second mixing chamber 63. This is because flocculation initiates immediately upon feeding and, if the liquid is fed into a narrow area, the fed liquid is included in a floc and fails to contribute to further formation of flocs.

Nozzles tips 73 of the pipe 62 and the pipe 67 for feeding a liquid to the second mixing chamber 63 are arranged above the liquid level so as to avoid contact of the nozzles with the liquid in the second mixing chamber 63. This is because flocs formed in the second mixing chamber 63 may adhere to the nozzles 73 of the pipe 62 and the pipe 67 to clog orifices of the nozzles 73.

This apparatus may be so designed as have not the drum for magnetic separation but a mechanism for separating flocs by filtration downstream from the precipitation of the flocs. The flocs herein contain the magnetic powder, thereby have a high specific gravity, and are liable to sink readily. Precipitation of a majority of flocs down to the bottom of the second mixing chamber 63 and subsequent filtration of the supernatant therefore enables water remediation even without magnetic separation.

This apparatus includes two mixing chambers, but an apparatus including only one mixing chamber will also function. However, an apparatus including two mixing chambers is more advantageous than an apparatus including one mixing chamber in the following points. Specifically, when plural processes are performed in two mixing chambers, the mixing chambers, associated pipes, and other facilities can separately undergo maintenance, unlike the case where plural processes are performed in one mixing chamber. This enables maintenance of one mixing chamber during operation of a process in the other mixing chamber and helps the apparatus to be easily operated without stopping the treating process of the contaminated water.

(2) Second Embodiment of Water Treatment Apparatus

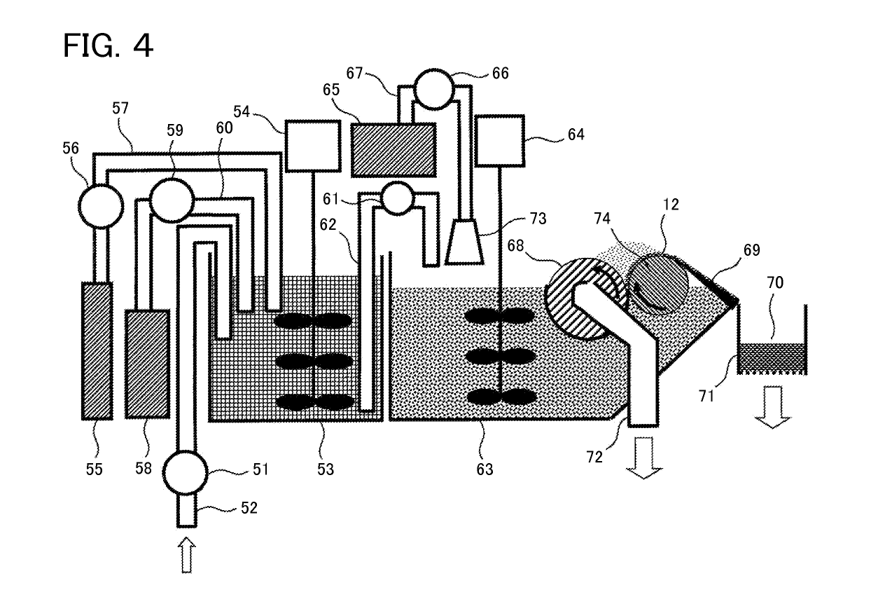

Of water treatment apparatuses according to the present invention, one including two drums of magnetic separation system will be illustrated on its basic structure with reference to FIG. 4.

In this apparatus, flocs are collected on a drum 68 having a meshed surface, and a small amount of water is sprayed from inside of the drum 68 so as to strip the flocs from the mesh of the drum 68. The flocs are then transferred to a drum 74 and adhere to the surface of the drum 74. The drum 74 is arranged adjacent to the drum 68. The drum 74 has a surface being not a mesh but a metal sheet.

Upon stripping of the flocs, the mesh surface of the drum 68 is scraped by a scraper according to a customary manner. In this process, the scraper may be caught in the mesh to damage the mesh.

The apparatus according to this embodiment, however, less suffers from damage by the scraper, because the scraper upon stripping of the flocs comes in contact with the metal sheet of the surface of the drum 74, which metal sheet is tougher than the mesh is.

(3) Third Embodiment of Water Treatment Apparatus

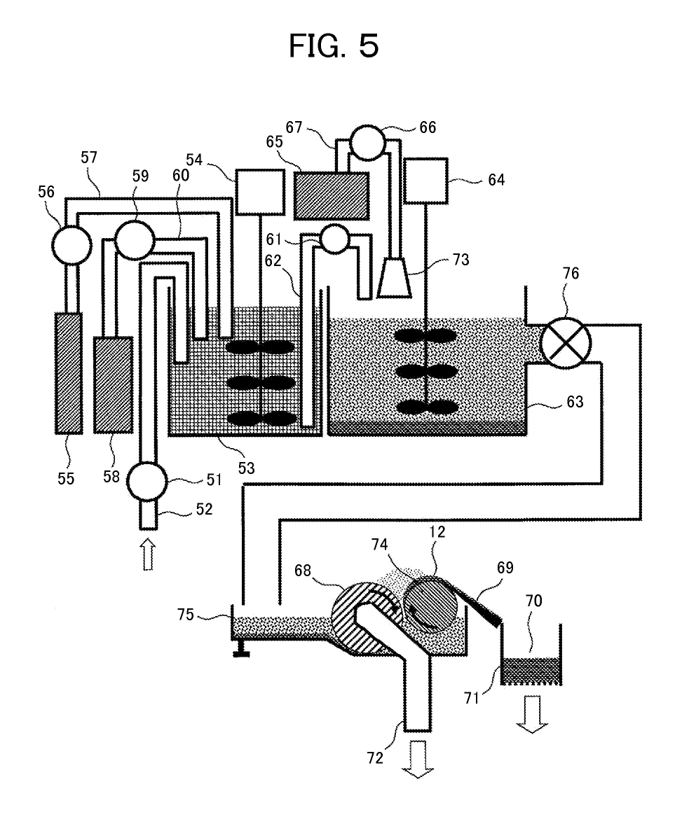

Of water treatment apparatuses according to the present invention, one including a separately-arranged floc removing chamber 75 of magnetic separation system will be illustrated on its basic structure with reference to FIG. 5.

The water treatment apparatus having this structure performs magnetic separation of flocs formed in a second mixing chamber 63 not in the same chamber but in another chamber (floc removing chamber 75), to which the flocs are transferred. The amount of treating water to be fed to the floc removing chamber 75 is controlled by a valve 76.

In the apparatus having this structure, a considerable percentage of the flocs remain in the second mixing chamber 63 to reduce the amount of flocs to be magnetically separated. This prevents the mesh of the drum 68 from clogging and takes a load off the maintenance of the mesh.

(4) Fourth Embodiment of Water Treatment Apparatus

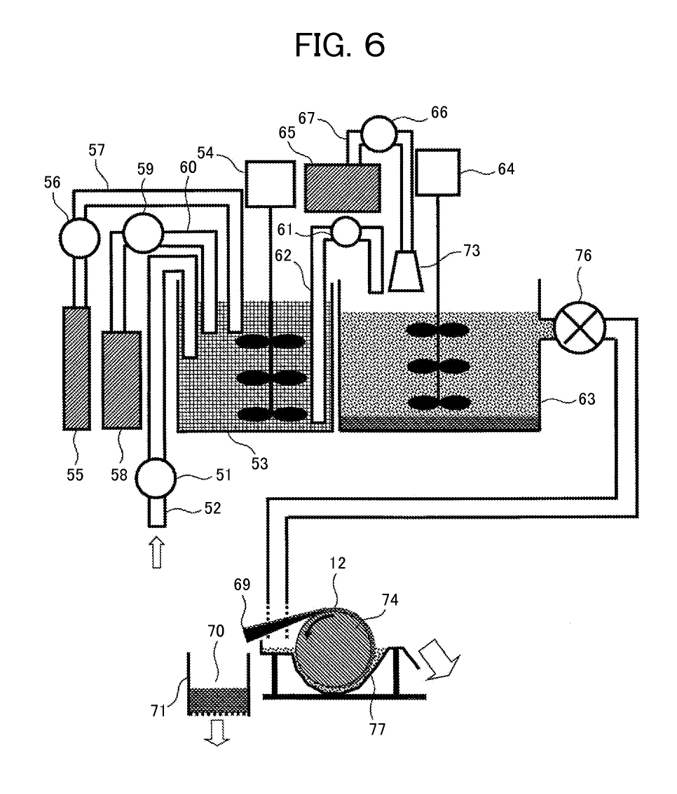

Of water treatment apparatuses according to the present invention, one employing magnetic separation system, having one drum, and including a separately-arranged floc removing chamber 77 will be illustrated on its basic structure with reference to FIG. 6.

The water treatment apparatus of this structure allows flocs to almost fully adhere to a drum 74 by arranging the drum 74 at a small distance from the bottom of the floc separating chamber 77. Thus, remediation (purification) of water is performed with one drum. The flocs adhered to the drum 74 are removed by a scraper. The apparatus of this structure enables remediation of water with one drum and thereby saves space of the floc separating chamber and, by extension, space of the apparatus.

(5) Fifth Embodiment of Water Treatment Apparatus

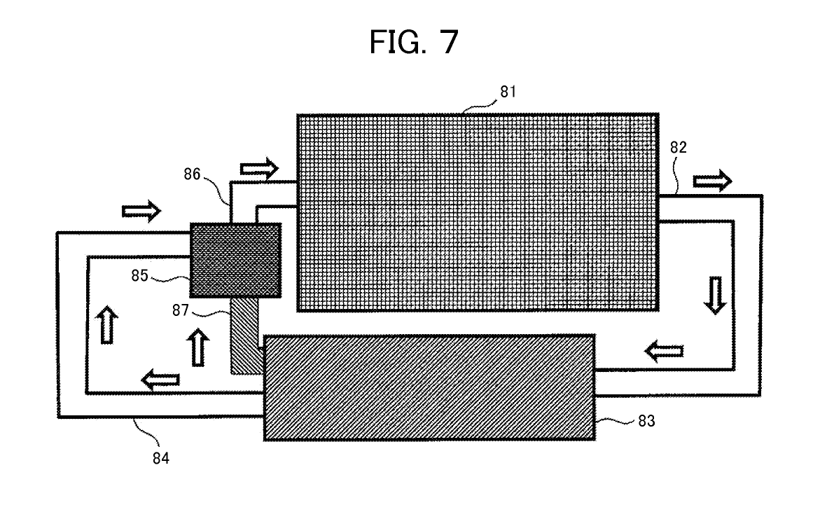

An oil-recovery and water-remediation system according to an embodiment of the present invention will be illustrated on its basic structure with reference to FIG. 7.

An oil extraction plant 81 performs blowing of steam to oil sand to separate oil from sand. The oil is heated by the blown steam to have a lower viscosity and is separated from the sand as oil-contaminated water, i.e., a mixture with hot water derived from the steam. The oil-contaminated water separates into oil and water due to difference in specific gravity, and the oil in an upper layer (so-called bitumen) is recovered to complete oil extraction. The extracted oil is separated into gasoline, heavy oil, asphalt, and other components based on different boiling points of them in a refining process and used in various industries.

Contaminated water containing oil and discharged from the oil extraction plant is fed via a pipe 82 to a water treatment apparatus 83. The contaminated water is remediated in this apparatus by removing oil, organic acids, and other components therefrom to give a treated water, and the treated water is fed via a pipe 84 to a steam generator 85. The treated water is heated in the steam generator 85 into steam, and the steam is fed via a pipe 86 to the oil extraction plant 81. The steam is reused in the process of extracting oil from oil sand.

In the process of heating the treated water to form steam in the steam generator 85, the flocs are transferred from the water treatment apparatus 83 by a conveyor belt 87. The flocs contain oils, organic acids, and the acid-containing water-soluble polymer, are burnt as a part of the fuel in the process of heating the treated water, and this reduces the amount of wastes.

Some Embodiments of the present invention will be illustrated below.

### Embodiment 1

(1) Magnetic Powder Modification

Initially, a magnetic powder was modified.

The modification is performed in the following manner. Initially, a 5 percent by weight hydrochloric acid (65.7 g, 0.09 mmol as HCl) was placed in a vessel containing a magnetic powder (elemental composition: Fe₃O₄, 2.4 g, 0.01 mmol), followed by stirring for one hour. The hydrochloric acid turned pale yellow and transparent, indicating that iron (Fe) on the surface of the magnetic powder was probably converted into FeCl₂ or FeCl₃ and dissolved; and that Fe on the surface was probably slightly ionized to allow chlorine ions to be present in the vicinity thereof or to adhere thereto. Next, the magnetic powder was collected by filtration, washed with water, dried under reduced pressure, and thereby yielded a surface-modified magnetic powder.

The surface of the surface-modified magnetic powder was analyzed by SEM-EDX to identify the presence of chlorine on the surface, in addition to iron and oxygen derived from the magnetic powder before treatment. The surface was cut away by several nanometers using electron beams to find that the chlorine signal almost disappeared, and iron and oxygen signals were observed, indicating that chlorine was bound to the surface of the modified magnetic powder. Chlorine was detected even after water washing, indicating that the surface was in the form of a salt between chlorine and iron.

(2) Contaminated Water Treatment Through Flocculation and Magnetic Separation

One liter of a test water containing 220 ppm of a naphthenic acid as an organic acid (containing 1 mmol of naphthenic acid) was prepared. This water is hereinafter referred to as a “simulated contaminated water.” The simulated contaminated water had a pH of 6.9.

The “naphthenic acid” is a generic name of carboxylic acids of cyclic hydrocarbons and has a molecular weight varying depending typically on the ring size and the presence or absence of a branched alkyl chain. The experiment herein employed a mixture of such naphthenic acids whose average molecular weight had been measured. The mixture was found to have an average molecular weight of 220. The naphthenic acid (mixture) was used in the form of ammonium salt, for good solubility in water.

The simulated contaminated water (one liter) with stirring was combined with 1.62 g (1 mmol in terms of the number of moles of iron ion) of a 10 percent by weight aqueous solution of iron(III) chloride as a trivalent metal salt and 5 mg of the surface-modified magnetic powder.

Next, 1.44 g (1 mmol in terms of the number of moles of carboxyl group as the acidic group) of a 5 percent by weight aqueous solution of a poly acrylic acid having carboxyl groups (having an average molecular weight of 250,000) was added, resulting in precipitation of flocs.

A bar magnet was placed in the simulated contaminated water and brought near to the flocs to gather the flocs thereon. The bar magnet was then slowly raised from the simulated contaminated water, and the residual simulated contaminated water was found to contain no visually-observable floc, demonstrating that most of the flocs had been removed.

The naphthenic acid in the simulated contaminated water after removal of flocs with the bar magnet was quantitatively analyzed to find that the naphthenic acid concentration was reduced to 10 ppm.

The result demonstrated that the coagulant and the magnetic separation process according to the present invention enable the removal of naphthenic acid dissolved in water.

Flocs could be collected and the naphthenic acid concentration was reduced to 10 ppm even upon the use of magnetic powders modified with sulfuric acid in a concentration of 10 percent by weight or nitric acid in a concentration of a 10 percent by weight, instead of the hydrochloric acid.

The results demonstrated that magnetic powder modification is possible not only with hydrochloric acid but also with another inorganic acid.

The magnetic powders modified with sulfuric acid and nitric acid, respectively, were analyzed by the same procedure as in the analysis of the surface of the magnetic powder modified with hydrochloric acid to find that iron, oxygen, and sulfur atoms, or iron, oxygen, and nitrogen atoms were respectively observed on the surface. Upon cutting away of the surface by several nanometers, the sulfur signal almost disappeared and only the iron and oxygen signals were observed in the magnetic powder modified with sulfuric acid. Likewise, the nitrogen signal almost disappeared and only the iron and oxygen signals were observed in the magnetic powder modified with nitric acid.

Even after water washing, the presence of sulfur atom or nitrogen atom was detected, indicating that the surface of the magnetic powder was in the form of a salt between sulfuric acid and iron or a salt between nitric acid and iron.

### Embodiment 2

Magnetic powder modification was performed with hydrochloric acid in a concentration of 2 percent by weight to find that the solution after one-hour stirring appeared colorless and transparent upon visual observation. The magnetic powder was then subjected to filtration, water washing, and drying processes, and the resulting magnetic powder was subjected to a flocculation experiment. Upon collection of the flocs with a bar magnet, a half or more of the entire flocs failed to be collected. Floc recovery was performed using magnetic powders modified with a sulfuric acid solution in a concentration of 4 percent by weight or a nitric acid solution in a concentration of 5 percent by weight to find that a half or more of the entire flocs failed to be collected.

A flocculation experiment was performed using a magnetic powder modified with hydrochloric acid in a concentration of 3 percent by weight, and flocs were collected with a bar magnet. As a result, the flocs could be collected and the naphthenic acid concentration was reduced to 10 ppm, as in Embodiment 1.

Likewise, flocs could be collected and the naphthenic acid concentration was reduced to 10 ppm even upon the use of magnetic powders modified with a sulfuric acid solution in a concentration of 5 percent by weight or a nitric acid solution in a concentration of 6 percent by weight.

The results demonstrated that, when magnetic powder modification is performed with a single acid, hydrochloric acid, sulfuric acid, and nitric acid should have concentrations of 3 percent by weight or more, 5 percent by weight or more, and 6 percent by weight or more, respectively.

### Embodiment 3

Magnetic powder modification was performed with hydrochloric acid in a concentration of 12 percent by weight, and the hydrochloric acid after one-hour stirring appeared yellow and transparent on visual observation. The magnetic powder was then subjected to filtration, water washing, and drying processes, and the resulting magnetic powder was found to have a weight reduced to about half the weight before modification.

Magnetic powders modified with hydrochloric acids in concentrations of 3 to 11 percent by weight had weights of 90% or more of the weight before modification.

The results demonstrate that a preferred hydrochloric acid concentration is 11 percent by weight or less for high-yield magnetic powder modification.

Upon the use of sulfuric acid instead of hydrochloric acid, modification at a concentration of 17 percent by weight or more caused the magnetic powder to be collected at a rate of 50% or less. Modification at a concentration of 16 percent by weight allowed the magnetic powder to be collected at a rate of 90% or more.

Also upon the use of nitric acid instead of hydrochloric acid, modification at a concentration of 19 percent by weight or more caused the magnetic powder to be collected at a recovery rate of 50% or less. Modification at a concentration of 18 percent by weight allowed the magnetic powder to be collected at a recovery rate of 90% or more.

The results in Embodiment 2 and Embodiment 3 demonstrate that, when magnetic powder modification is performed with a single acid, hydrochloric acid, sulfuric acid, and nitric acid preferably have concentrations of 3 to 11 percent by weight, 5 to 16 percent by weight, and 6 to 18 percent by weight, respectively.

### Embodiment 4

Magnetic powder modification was performed with a solution containing 5 percent by weight of sodium chloride and 2 percent by weight of hydrochloric acid to find that the solution after one-hour stirring appeared pale yellow and transparent. The magnetic powder was then filtrated, washed with water, and dried. The resulting magnetic powder was subjected to a flocculation experiment in which flocs were to be collected with a bar magnet. The flocs could be collected and the naphthenic acid concentration was reduced to 10 ppm as in Embodiment 1.

Likewise, magnetic powder modification was performed with a solution containing 5 percent by weight of sodium chloride and 2 percent by weight of sulfuric acid or a solution containing 5 percent by weight of sodium chloride and 2 percent by weight of nitric acid, and the solutions after one-hour stirring appeared pale yellow and transparent on visual observation. The magnetic powders were then filtrated, washed with water, and dried. The resulting magnetic powder was subjected to a flocculation experiment in which flocs were to be collected with a bar magnet. The flocs could be collected and the naphthenic acid concentration was reduced to 10 ppm as in Embodiment 1.

The results demonstrated that addition of sodium chloride to an acid enables magnetic powder modification with the acid even at a low concentration.

Flocs could be collected with a bar magnet and the naphthenic acid concentration was reduced to 10 ppm as with the use of sodium chloride, even when magnetic powder modification was performed with a solution containing, instead of sodium chloride, potassium nitrate, magnesium chloride, magnesium sulfate, or calcium chloride each in a concentration of 5 percent by weight.

The results demonstrated that a magnetic powder can be modified with an acid even at a low concentration by allowing the acid to further contain an alkali metal salt or alkaline earth metal salt.

### Embodiment 5

A flocculation experiment was performed by the procedure of Embodiment 1, except for using 5 liters of the simulated contaminated water as a solution of 220 ppm of naphthenic acid having a pH of 6.9, and flocs were to be collected with a bar magnet. As a result, the flocs could be collected as in Embodiment 1, but the naphthenic acid concentration was found to be 110 ppm. Independently, 1.62 g (1 mmol in terms of the number of moles of iron ion) of a 10 percent by weight aqueous solution of iron(III) chloride as a trivalent metal salt was combined with 5 mg of the surface-modified magnetic powder and 50 g of sodium chloride.

Next, 7.2 g (5 mmol in terms of the number of moles of carboxyl group as the acidic group) of a 5 percent by weight aqueous solution of a poly acrylic acid having carboxyl groups (having an average molecular weight of 250,000) was added, resulting in precipitation of flocs.

Upon collection of the flocs with a bar magnet, the flocs could be collected as in Embodiment 1, and the simulated contaminated water after collection of flocs was found to have a naphthenic acid concentration of 10 ppm.

The result demonstrated that the addition of sodium chloride facilitates inclusion of the naphthenic acid in the flocs.

Independently, an experiment was performed by the above procedure, except for adding sodium chloride in an amount of 200 g. The simulated contaminated water after collection of flocs was found to have a naphthenic acid concentration of 4 ppm.

This demonstrated that a higher percentage of the naphthenic acid can be removed in a higher amount of sodium chloride to be added, i.e., at a higher sodium chloride concentration in the contaminated water.

### Embodiment 6

An experiment was performed by the procedure of Embodiment 5, except for adding magnesium chloride (50 g) instead of sodium chloride (50 g). The simulated contaminated water after collection of flocs was found to have a naphthenic acid concentration of 20 ppm.

This demonstrated that the addition of a chloride as a salt facilitates inclusion of the naphthenic acid in the flocs.

### Embodiment 7

An experiment was performed by the procedure of Embodiment 5, except for adding magnesium sulfate (50 g) instead of sodium chloride (50 g). The simulated contaminated water after collection of flocs was found to have a naphthenic acid concentration of 20 ppm.

Another experiment was performed by the procedure of Embodiment 5, except for adding potassium chloride (50 g) instead of sodium chloride (50 g). The simulated contaminated water after collection of flocs was found to have a naphthenic acid concentration of 10 ppm.

These demonstrated that the addition of an alkali metal salt or alkaline earth metal salt facilitates inclusion of the naphthenic acid in the flocs.

### Embodiment 8

An experiment was performed by the procedure of Embodiment 1, except for using 1.72 g (1 mmol in terms of the number of moles of carboxyl group as an acidic group) of a 5 percent by weight aqueous poly methacrylic acid solution instead of 1.44 g of the 5 percent by weight aqueous poly acrylic acid solution. The simulated contaminated water after collection of flocs was found to have a naphthenic acid concentration of down to 10 ppm.

This demonstrated that organic acids dissolved in water can be removed even by using a poly methacrylic acid as a carboxyl-containing polymer instead of the poly acrylic acid.

### Embodiment 9

An experiment was performed by the procedure of Embodiment 1, except for using 1.84 g (1 mmol in terms of the number of moles of sulfonic group) of a 10 percent by weight aqueous poly styrenesulfonic acid solution instead of 1.44 g of the 5 percent by weight aqueous poly acrylic acid solution. The simulated contaminated water after collection of flocs was found to have a naphthenic acid concentration of down to 10 ppm.

This demonstrated that organic acids dissolved in water can be removed even by using a sulfonic-containing water-soluble polymer as the acid-group-containing polymer.

### LIST OF REFERENCE NUMERALS

4 magnetic powder
5 surface-modified magnetic powder
6 organic acid
7 iron ion
8 carboxyl-containing water-soluble polymer
9 floc including organic acid and magnetic powder
51, 56, 59, 61, 66 pump
52, 57, 60, 62, 67, 72, 82, 84, 86 pipe
53 first mixing chamber
54, 64 overhead stirrer
55 dilute hydrochloric acid reservoir
58 reservoir for aqueous solution of metal salts
63 second mixing chamber
65 reservoir for the aqueous solution of an acidic-group-containing polymer
68, 74 drum
69 scraper
70 floc
71 floc collection device
73 nozzle of pipe for feeding liquid to second mixing chamber
75, 77 floc removing chamber
76 valve
81 oil extraction plant
83 water treatment apparatus
85 steam generator
87 conveyor belt

1. A coagulant capable of forming a floc with an organic acid in contaminated water, the coagulant comprising:
an iron oxide bearing an inorganic salt on surface; and
an aqueous solution of an acidic-group-containing polymer.

2. The coagulant of claim 1, further comprising a trivalent metal salt.

3. The coagulant of claim 2, wherein the trivalent metal salt comprises an iron salt or an aluminum salt.

4. The coagulant of claim 2, wherein the trivalent metal salt comprises a salt of hydrochloric acid.

5. The coagulant of claim 1, wherein the iron oxide comprises Fe3O4.

6. The coagulant of claim 1, wherein the acidic-group-containing polymer comprises a poly acrylic acid.

7. The coagulant of claim 6, wherein the poly acrylic acid has an average molecular weight of 2,000 to 1,000,000.

8. The coagulant of claim 6, wherein the poly acrylic acid has an average molecular weight of 100,000 to 500,000.

9. The coagulant of claim 1, wherein the acidic group of the acidic-group-containing polymer forms an alkali metal salt.

10. A method for the remediation of contaminated water by converting an organic acid in the contaminated water into a floc and removing the floc, the method comprising the steps of:
adding an iron oxide bearing an inorganic salt on surface to the contaminated water;
adding an aqueous solution of an acidic-group-containing polymer to the contaminated water to precipitate a floc; and
magnetically separating the precipitated floc.

11. The water remediation method of claim 10, further comprising the steps of:
adding an acidic or basic aqueous solution to the contaminated water to separate the iron oxide; and
recovering the separated iron oxide.

12. The water remediation method of claim 10, further comprising the step of controlling the contaminated water to have a pH of 5 to 7 before the step of adding the aqueous solution of an acidic-group-containing polymer.

13. A water treatment apparatus for the remediation of contaminated water, the apparatus comprising:
a mechanism for stirring the contaminated water;
a mechanism for adding an iron oxide bearing an inorganic salt on surface to the contaminated water;
a mechanism for adding an aqueous solution of an acidic-group-containing polymer to the contaminated water to form a floc; and
a mechanism for magnetically separating the formed floc.

14. The water treatment apparatus of claim 13, further comprising:
a mechanism for measuring a pH of the contaminated water; and
a mechanism for adding an acid or a base to the contaminated water, both mechanisms arranged upstream from the mechanism for adding the iron oxide particles.
